(19) United States
(12) Patent Application Publication
(10) Pub. No.: US 2025/0367585 A1
(43) Pub. Date: Dec. 4, 2025

(54) FILTER ELEMENT AND FILTER SYSTEM

(71) Applicant: MANN+HUMMEL GmbH, Ludwigsburg (DE)

(72) Inventors: Sascha ROTH, Schwegenheim (DE); Klaus-Dieter RUHLAND, Meckenheim (DE); Michael KAUFMANN, Meckenheim (DE); Dennis STARK, Mauer (DE); Pascal NEEF, Trossingen (DE); Christoph WITTMERS, Bietigheim-Bissingen (DE); Andreas WEBER, Freiberg (DE); Mario RIEGER, Ludwigsburg (DE); Markus HANSELMANN, Lauffen (DE); Peter PEKNY, Neuenmarkt (DE); Eva HALLBAUER, Himmelkron (DE); Daniel SCHMID, Sachsenheim (DE); Steffen GERLACH, Nufringen (DE); Friedrich KUPFER, Marklkofen (DE); Johannes GRAD, Simbach (DE); Pedro Miguel PEREIRA MADEIRA, Bietigheim-Bissingen (DE); Dieter WEISS, Gefrees (DE); Philipp HETTKAMP, Steinheim (DE)

(21) Appl. No.: 19/299,496

(22) Filed: Aug. 14, 2025

Related U.S. Application Data
(63) Continuation of application No. PCT/EP2024/051029, filed on Jan. 17, 2024.

(30) Foreign Application Priority Data
Feb. 16, 2023 (DE) 102023103864.8

(51) Int. Cl. B01D 46/00; B01D 46/52

(52) U.S. Cl. CPC B01D 46/0036; B01D 46/0001; B01D 46/522

(57) ABSTRACT

A filter element for fluid has a filter medium body with a flow-through medium arranged transversely to a fluid flow direction. A region of the flow-through medium between an inlet surface and an outlet surface of the filter medium body is filled with adsorption medium in intermediate spaces of the flow-through medium. A fluid-permeable cover medium covers the region at a peripheral rim of the inlet surface and/or the outlet surface. A filter system has a filter housing having an inlet and an outlet for fluid. The filter element is exchangeably arranged in the filter housing between a raw-side and a clean-side. A method for producing the filter element includes filling adsorption medium into intermediate spaces of the flow-through medium between an inlet surface and an outlet surface. The region is covered with a fluid-permeable cover medium at a peripheral rim of the inlet surface and/or the outlet surface.

### CROSS-REFERENCE TO RELATED APPLICATIONS

This application is a continuation application of international application No. PCT/EP2024/051029 having an international filing date of Jan. 17, 2024, and designating the United States, the international application claiming a priority date of Feb. 16, 2023, based on prior filed German patent application No. 10 2023 103 864.8, the entire contents of the aforesaid international application and the aforesaid German patent application being incorporated herein by reference.

### BACKGROUND

The invention concerns a filter element for filtering a fluid, for example air, as well as a filter system for filtering a fluid, for example air, including a filter element, and a method for producing a filter element for filtering a fluid, for example air.

Adsorption filters are used in motor vehicles, for example, in order to adsorb fuel vapors of the fuel tank and are arranged in tank venting lines, for example, in order to avoid an unwanted emission of hydrocarbons through the venting line into the environment. In this context, activated carbon which adsorbs and thus fixes the hydrocarbons may be used as an adsorption medium, for example. The activated carbon in such an adsorption filter is commonly configured as a granular material, honeycomb body, pellet, or as compressed granular material.

Currently known activated carbon elements for filtering air have a flat or round shape. The elements are produced from semi-finished products such as nonwovens with activated carbon application. Wound layers, round stacked layers, flat, but also folded activated carbon media are used as a basis for such elements.

DE 10 2010 019 046 A1 discloses providing a filter layer, including a flat and a corrugated filter web connected thereto, with an additional corrugated filter web, wherein the two corrugated filter webs include different corrugations, for example amplitudes and/or wavelengths. Activated carbon is filled for example into each corrugation of the corrugations of the additional corrugated filter layer. Granulated activated carbon and, alternatively, finely granulated or dust-type activated carbon is used. Such dust-type activated carbon may possibly arise in other application fields as a waste product. In comparison to granular activated carbon or activated carbon in pellet form, activated carbon dust has a significantly enlarged surface area, whereby the adsorption capacity is increased. The corrugations of the first corrugated filter web, which are located between the corrugations filled with the dust-type activated carbon as adsorption medium, are moreover closed off either at one or at the other longitudinal end.

### SUMMARY

It is an object of the invention to provide a filter element for filtering a fluid, for example air, which may be produced in a beneficial configuration.

A further object is to provide a filter system with a filter element which may be produced in a beneficial configuration.

A further object is to provide a method for producing such a filter element.

The aforementioned object is solved according to an aspect of the invention by a filter element for filtering a fluid, for example air, including at least one filter medium body including a flow-through medium arranged transversely to a flow direction of the fluid, including a raw-side inlet surface and a clean-side outlet surface, wherein at least one region between the inlet surface and the outlet surface is filled with an adsorption medium, for example with a particle-type or dust-type activated carbon, and arranged in intermediate spaces of the flow-through medium, wherein the region is covered with a fluid-permeable cover medium, for example a spunbond nonwoven, at a peripheral rim of the inlet surface and/or of the outlet surface.

The further object is solved according to another aspect of the invention by a filter system for filtering a fluid, for example air, including a filter housing, which includes at least one inlet for inflow of the fluid flow and at least one outlet for outflow of the purified fluid flow, and including a filter element for filtering the fluid, exchangeably arranged in the filter housing between a raw-side and a clean-side, including at least one filter medium body including a flow-through medium arranged transversely to a flow direction of the fluid, including a raw-side inlet surface and a clean-side outlet surface, wherein at least one region between the inlet surface and the outlet surface is filled with an adsorption medium, for example with a particle-type or dust-type activated carbon, and arranged in intermediate spaces of the flow-through medium, wherein the region is covered with a fluid-permeable cover medium, for example a spunbond nonwoven, at a peripheral rim of the inlet surface and/or of the outlet surface.

The further object is solved according to another aspect of the invention by a method for producing a filter element for filtering a fluid, for example air, including at least one filter medium body including a flow-through medium arranged transversely to a flow direction of the fluid, including a raw-side inlet surface and a clean-side outlet surface, at least including: filling at least one region of intermediate spaces of the flow-through medium between the inlet surface and the outlet surface with an adsorption medium, for example with a particle-type or dust-type activated carbon, covering the region at a peripheral rim of the inlet surface and/or of the outlet surface by a fluid-permeable cover medium, for example a spunbond nonwoven.

Embodiments and advantages of the invention will be apparent from the description and the accompanying drawings.

According to an aspect of the invention, a filter element for filtering a fluid, for example air, is proposed, including at least one filter medium body including a flow-through medium arranged transversely to the flow direction of the fluid, including a raw-side inlet surface and a clean-side outlet surface, wherein at least one region between the inlet surface and the outlet surface is filled with an adsorption medium, for example with a particle-type or dust-type activated carbon, and arranged in intermediate spaces of the flow-through medium. The region is covered with a fluid-permeable cover medium, for example a spunbond nonwoven, at a peripheral rim of the inlet surface and/or of the outlet surface.

In the proposed filter element, intermediate spaces of a flow-through medium, for example, a filter medium such as a nonwoven, paper or the like, are filled with an adsorption medium such as activated carbon, for example. These intermediate spaces may represent the region between the flow-through medium and the inlet surface or the outlet surface, for example. However, it is also possible that the medium itself, for example, a foam-type medium, includes intermediate spaces filled with the adsorption medium. The adsorption medium is retained in the filter medium body because the region is covered with a fluid-permeable cover medium, for example, a spunbond nonwoven, which retains the adsorption medium.

The filter medium body may be configured as a filter bellows with a folded filter medium body in which intermediate spaces between the folds are filled or coated with adsorption medium. Both required filtration functions of dust removal and harmful substance removal may be realized in a compact available space within the filter element.

As an alternative, the filter medium body may include a wavy or corrugated flow-through medium, for example, filter paper, combined with a flat filter medium, for example, filter paper. In this way, channels are formed in the wavy or corrugated flow-through medium. For example, one layer of wavy or corrugated medium may be covered with a layer of flat medium and wound, whereby channels are formed which may be closed alternatingly at the inflow side or outflow side and, correspondingly, may be alternatingly empty or contain adsorption medium. As an alternative, all channels may include adsorption medium.

The thus produced filter element may serve not only for filtration of dust but also for adsorption of harmful substances, for example. The filter element may thus be used as an activated carbon filter element. The filter element in this context may be beneficially manufactured in arbitrary configurations. For example, cubic filter elements but also filter elements with slanted or trapezoidal configuration or other beneficial configurations may be realized. In the embodiment with wound flow-through medium, a round or oval configuration may be present. Configurations of wheelhouse filters may be used also, for example.

The filter medium body of the filter element serves thus as a support structure for the adsorption medium. The pre-manufactured filter medium body may beneficially be filled with the adsorption medium after its manufacture.

For example, particle-type or dust-type activated carbon may be filled as an adsorption medium into the intermediate spaces of the flow-through medium. Activated carbon is usually available as carbon chips or carbon beads.

The proposed filter element may be used in motor vehicles in connection with internal combustion engines for adsorption of hydrocarbons but also as a cabin filter. Use in an air purifier, in an exhaust hood, for example, in a range hood, is also conceivable.

According to an embodiment of the filter element, the flow-through medium may be folded in a zigzag shape transversely to the flow direction, wherein the region between a fold base of folds of the filter medium body and a fold tip of the folds is filled with the adsorption medium at an inflow side and/or outflow side of the filter medium body. The cover medium may be arranged at the fold tips. In this way, the intermediate spaces between the folded medium and the inflow side and/or outflow side may be beneficially filled with the adsorption medium. The cover medium may be glued to the fold tips and thus prevent that the adsorption medium may escape again from the filled region to the exterior.

According to an embodiment of the filter element, glue tracks may be arranged along an unwind of the folds of the flow-through medium at the inflow side and/or at the outflow side of the folds of the filter medium body. In this context, the cover medium may be glued to the fold tips of the folds along the glue tracks. Glue tracks which, for example, are applied anyways for fixation of the folds in the filter medium body of the filter element may be beneficially used for joining the cover medium to the fold tips. In this way, the cover medium may be glued in a simple manner to the fold tips along the glue tracks and thus be permanently connected.

According to an embodiment of the filter element, glue sections which extend across the fold tip may be arranged at the inflow side and/or at the outflow side, respectively. As an alternative or in addition, glue gaps which extend across the fold base may be arranged at the outflow side or at the inflow side. In this context, the cover medium may be glued to the glue sections. The glue tracks may thus be interrupted along the unwind of the folds. In this way, glue may be saved in that the glue sections are applied only where they are needed for fixation of the folds, namely at the fold tips. In this way, the cover medium may also be glued at the fold tips to the flow-through medium and in this way reliably and permanently cover the region in which the adsorption medium is filled in.

According to an embodiment of the filter element, the filter medium body may include a wavy or corrugated flow-through medium, for example, filter paper, combined with a flat filter medium, for example, filter paper. In this way, channels are formed in the wavy or corrugated flow-through medium. For example, a layer of wavy or corrugated medium may be covered and wound with a layer of flat medium, whereby channels form which may be closed alternatingly at the inflow side or outflow side and, correspondingly, may be alternatingly empty or contain adsorption medium. As an alternative, all channels may contain adsorption medium.

The channels may be filled or coated with adsorption medium at one side, for example at the clean air side, or even at both sides, clean air side and raw air side. In this way, both required filtration functions of dust removal and harmful substance removal may be realized in a compact available space inside a filter element. Optionally, by means of an applied nonwoven layer, a grid or the like, the adsorption medium may be retained in the channels. As an alternative, this may be realized also by glue which forms a cover for closing the respective channel.

According to an embodiment of the filter element, the filter medium body may be arranged in a reinforcement frame, with at least one seal which is arranged peripherally at least partially continuously at least in sections at an outer peripheral side of the flow-through medium at the inlet surface or at the outlet surface of the filter medium body. For example, the seal may be connected by foaming or injection molding to the reinforcement frame. In this context, the cover medium may be connected to the seal. For example, the cover medium may be tightly connected to the seal. In this manner, the cover medium, for example, a spunbond nonwoven, may be connected at the inlet surface and/or at the outlet surface in a simple and inexpensive manner to the filter element. In this way, it is also ensured that the cover medium tightly covers the region filled with the adsorption medium.

According to an embodiment of the filter element, the cover medium may be connected to the reinforcement frame by foaming on or molding on the seal. In this manner, the cover medium, for example, a spunbond nonwoven, may be connected in a simple and inexpensive manner to the filter element at the inlet surface and/or at the outlet surface. In this way, it is also ensured that the cover medium tightly covers the region filled with the adsorption medium.

According to an embodiment of the filter element, the filter medium body may include a grid structure at the inflow side and/or at the outflow side. In this context, the cover medium may be connected to the grid structure. The grid structure, for example, a perforated plate, may support the fold edges of the flow-through medium against the pressure of the flow and protect against mechanical damage at the other side. The cover medium may be fastened beneficially at this grid structure, for example, glued thereto, and prevent escape of the filled-in adsorption medium in this way.

According to a further aspect of the invention, a filter system for filtering a fluid, for example air, is proposed, including a filter housing, which includes at least one inlet for inflow of the fluid flow and at least one outlet for outflow of the purified fluid flow, and including a filter element for filtering the fluid arranged exchangeably in the filter housing between a raw-side and a clean-side, including at least one filter medium body including a flow-through medium arranged transversely to the flow direction of the fluid, including a raw-side inlet surface and a clean-side outlet surface. In this context, at least one region between the inlet surface and the outlet surface is filled with an adsorption medium, for example with a particle-type or dust-type activated carbon, and arranged in intermediate spaces of the flow-through medium. The region is covered with a fluid-permeable cover medium, for example, a spunbond nonwoven, at a peripheral rim of the inlet surface and/or of the outlet surface.

In the filter element of the proposed filter system, intermediate spaces of a flow-through medium, for example, of a filter medium, are filled with an adsorption medium such as activated carbon. These intermediate spaces may represent the region between the flow-through medium and the inlet surface or the outlet surface, for example. However, it is also possible that the medium itself, for example, a foam-type medium, includes intermediate spaces filled with the adsorption medium. The adsorption medium is retained in the filter medium body because the region is covered with a fluid-permeable cover medium, for example, a spunbond nonwoven.

The filter system may thus serve not only for filtration of dust but also for adsorption of harmful substances. Thus, the filter element may be utilized for activated carbon filtration. In this context, the filter element may be manufactured beneficially in arbitrary configurations. For example, cubic filter elements but also filter elements with a slanted or trapezoidal configuration or other beneficial configurations may be realized. Configurations of wheelhouse filters may be used also, for example.

The filter medium body of the filter element serves thus as a support structure for the adsorption medium. The pre-manufactured filter medium body may beneficially be filled with the adsorption medium after the manufacture.

For example, particle-type or dust-type activated carbon may be filled as adsorption medium into the intermediate spaces of the flow-through medium. Activated carbon is usually available as carbon chips or carbon beads.

The proposed filter element may be used in motor vehicles in connection with internal combustion engines for adsorption of hydrocarbons but also as a cabin filter. Use in an air purifier, in an exhaust hood, for example, in a range hood, is also conceivable.

According to an embodiment of the filter system, in the filter housing, fluidly upstream in front of the filter element, a pre-separation stage, for example a cyclone pre-separator, may be arranged. As an alternative or in addition, fluidly downstream behind the filter element a safety element may be arranged. A pre-separation stage may thus be connected fluidly upstream to the filter medium body. In this context, paper bellows, nonwoven bellows, bellows of separator foams, single layer or multilayer, but also cyclone pre-separators may be used as pre-separators, for example. Usually, secondary filter elements may be used as safety elements. Combinations of pre-separation stages and safety elements may be used beneficially together with the filter element filled with adsorption medium.

According to an embodiment of the filter system, the filter element may be configured as an insertion filter element which is inserted or insertable into the filter housing transversely to the main flow axis of the fluid. Such a construction is advantageous for exchange of the filter element when loaded.

According to a further aspect of the invention, a method is proposed for producing a filter element for filtering a fluid, for example air, including at least one filter medium body including a flow-through medium arranged transversely to a flow direction of the fluid, including a raw-side inlet surface and a clean-side outlet surface. The method includes at least: filling at least a region of intermediate spaces of the flow-through medium between the inlet surface and the outlet surface with an adsorption medium, for example with a particle-type or dust-type activated carbon, as well as covering the region by a fluid-permeable cover medium, for example a spunbond nonwoven, at a peripheral rim of the inlet surface and/or of the outlet surface.

According to the proposed method, in a filter element intermediate space of a flow-through medium of the filter element, for example, of a filter medium, are filled with an adsorption medium such as activated carbon, for example. These intermediate spaces may represent the region between the flow-through medium and the inlet surface or the outlet surface, for example. However, it is also possible that the medium itself, for example, a foam-type medium, includes intermediate spaces filled with the adsorption medium. The adsorption medium is retained in the filter medium body because the region is covered with a fluid-permeable cover medium, for example, a spunbond nonwoven.

The thus produced filter element may serve not only for filtration of dust but also for adsorption of harmful substances. In this way, the filter element may be used for activated carbon filtration. In this context, the filter element may beneficially be manufactured in arbitrary configurations. For example, cubic filter elements but also filter elements with a slanted or trapezoidal configuration or other beneficial configurations may be realized. Configurations of wheelhouse filters may be used also, for example.

The filter medium body of the filter element serves thus as a support structure for the adsorption medium. The pre-manufactured filter medium body may beneficially be filled with the adsorption medium after its manufacture.

For example, particle-type or dust-type activated carbon may be filled as adsorption medium into the intermediate spaces of the flow-through medium. Activated carbon is usually available as carbon chips or carbon beads.

The proposed filter element may be used in motor vehicles in connection with internal combustion engines for adsorption of hydrocarbons but also as a cabin filter. Use in an air purifier, in an exhaust hood, for example, in a range hood, is also conceivable.

According to an embodiment, the method may include at least the steps: inserting the filter medium body with the inlet surface or outlet surface accessible for filling into a receptacle and loading the receptacle into a filling station; filling the region of the filter medium body through the accessible inlet surface or outlet surface with the adsorption medium; covering the region at the inlet surface or outlet surface with the cover medium.

According to the proposed method, pre-manufactured bellows may be placed into a receptacle and loaded into a filling station. Below the filling station, the adsorption medium, for example activated carbon, may flow into intermediate spaces of the filter medium body. In this context a vibration plate operated at high frequency may be used in order to achieve compaction of the adsorption medium. Subsequently, a transport to a next station may take place where a cover medium, for example, a spunbond nonwoven, is glued or welded across the filled region of the filter medium body. This may be realized, for example, with glue tracks on fold edges of the filter medium body.

According to an embodiment of the method, for a two-sided filling of the filter medium body, at least these further steps may be employed: rotating the filter medium body in the receptacle so that the region not yet filled is accessible for filling and loading the receptacle into the filling station; filling the region of the filter medium body with the adsorption medium; covering the region at the inlet surface or outlet surface with the cover medium. In case of a two-sided filling of the filter medium body with the adsorption medium, the described process may be repeated with the turned-over filter medium body.

According to an embodiment of the method, glue tracks along an unwind of the folds of the flow-through medium may be arranged at the inflow side and/or at the outflow side of folds of the filter medium body, wherein the cover medium is glued to the fold tips of the folds along the glue tracks. Beneficially, the cover medium may thus be glued directly to the filter medium body so that the filled region is tightly covered.

According to an embodiment of the method, the filter medium body may be arranged in a reinforcement frame, with at least one seal which is arranged peripherally at least partially continuously at least in sections at an outer peripheral side of the flow-through medium at the inlet surface or at the outlet surface of the filter medium body, for example connected to the reinforcement frame by being foamed or molded on. In this context, the cover medium may be connected to the seal. For example, the cover medium may be embedded in the seal by foaming or molding. A further processing of the filter medium body may thus be realized beneficially with or without the reinforcement frame, depending on the seal type. The filled region may be covered tightly with the cover medium which is tightly connected to the seal so that the filled-in adsorption medium is retained in the intermediate spaces of the flow-through medium of the filter medium body.

According to an embodiment of the method, a grid structure may be arranged at the filter medium body at the inflow side and/or at the outflow side. In this context, the cover medium may be connected to the grid structure. In this alternative embodiment, the cover medium may be beneficially directly applied to the grid structure, for example, a perforated plate, and tightly connected thereto.

### BRIEF DESCRIPTION OF DRAWINGS

Further advantages will be apparent from the following description of the drawing figures. In the drawings, embodiments of the invention are illustrated. The drawings and the description contain numerous features in combination. A person of skill in the art will consider the features expediently also individually and combine them to expedient further combinations.

FIG. 1 shows a longitudinal section through a filter medium body of a filter element according to an embodiment of the invention in which a region between the inlet surface and the outlet surface is filled with an adsorption medium, for example with a particle-type or dust-type activated carbon, and arranged in intermediate spaces of the flow-through medium.

FIG. 2 shows an enlarged detail of the filter medium body according to FIG. 1 in which a region between a flow-through medium and the outlet surface is filled with the adsorption medium.

FIG. 3 shows an enlarged detail of the filter medium body according to FIG. 1 in which the region between the flow-through medium and the outlet surface as well as a region between the flow-through medium and the inlet surface is filled with the adsorption medium.

FIG. 4 shows a longitudinal section through a filter medium body of a filter element with a fluidly upstream arranged pre-separation stage according to a further embodiment of the invention.

FIG. 5 shows a longitudinal section through a filter medium body of a filter element with a fluidly upstream arranged pre-separation stage and a fluidly downstream arranged safety element according to a further embodiment of the invention.

FIG. 6 shows a longitudinal section through a filter element according to an embodiment of the invention.

FIG. 7 shows an enlarged detail of the filter element according to FIG. 6 with focus on a reinforcement frame and seal.

FIG. 8 shows an isometric illustration of a filter element according to a further embodiment of the invention with a view of the outlet surface.

FIG. 9 shows an exploded illustration of a filter element according to a further embodiment of the invention.

FIG. 10 shows a longitudinal section of a filter system with a filter element according to an embodiment of the invention.

FIG. 11 shows a schematic illustration of a method for producing a filter element according to an embodiment of the invention.

FIG. 12 shows in schematic illustration a plan view of a leading edge of channels of a filter element according to a further embodiment of the invention in which wavy or corrugated medium is combined with flat medium.

FIG. 13 shows a view with channels filled partially with adsorption medium of a filter element according to FIG. 12.

FIG. 14 shows a longitudinal section through a filter element according to a further embodiment of the invention in which a region between the inlet surface and the outlet surface is filled with an adsorption medium and arranged in intermediate spaces of the flow-through medium.

FIG. 15 shows a longitudinal section through a filter element according to a further embodiment of the invention in which a region between the inlet surface and the outlet surface is filled with an adsorption medium and arranged in intermediate spaces of the flow-through medium.

FIG. 16 shows an isometric view of a filter element with a wound filter medium body according to FIG. 12.

FIG. 17 shows a longitudinal section of a filter system with a filter element with wound filter medium body according to FIG. 16.

### DETAILED DESCRIPTION

In the drawing figures, same or same-type components are identified with the same reference characters. The drawing figures show only examples and are not to be understood as limiting.

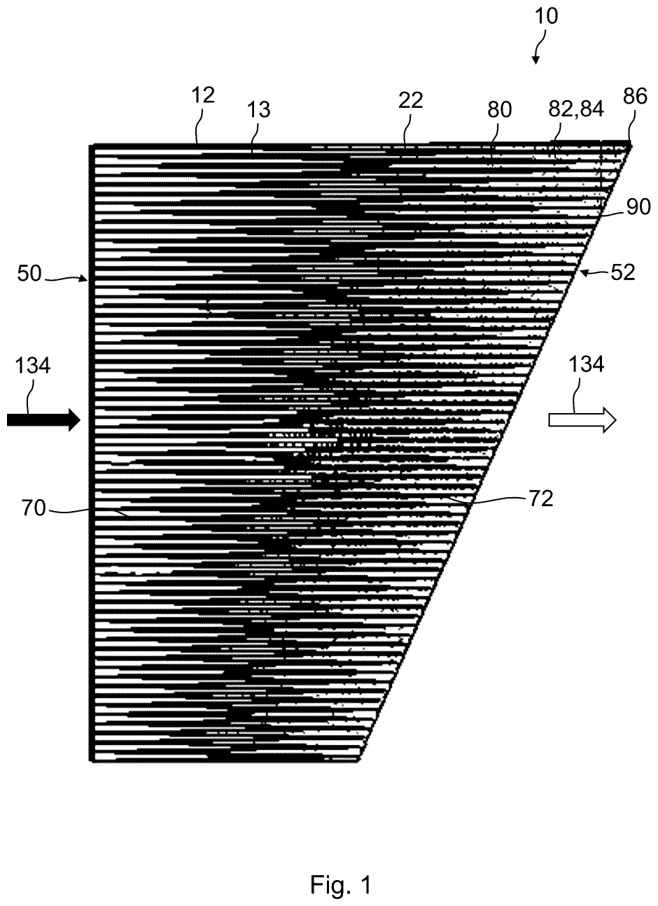

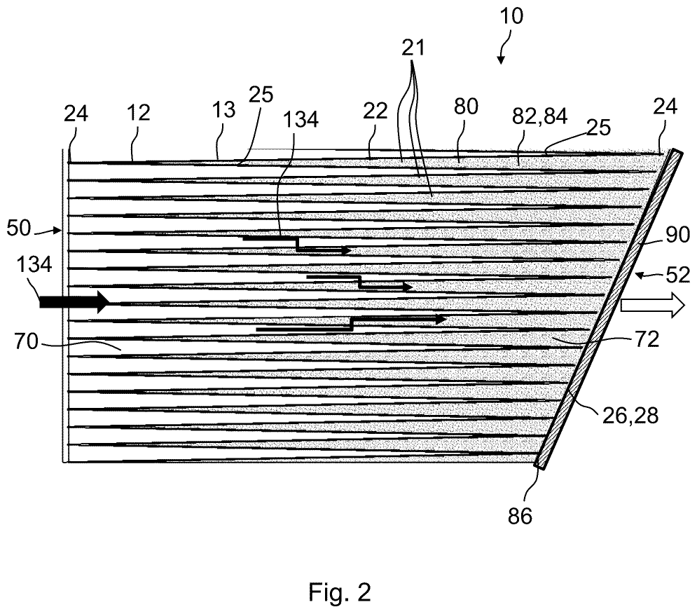

FIG. 1 shows a longitudinal section through a filter medium body 12 of a filter element 10 according to an embodiment of the invention in which an outflow-side region 80 between the inlet surface 50 and the outlet surface 52 is filled with an adsorption medium 82, for example with particle-type or dust-type activated carbon 84, and arranged in intermediate spaces 21 of the flow-through medium 13. FIG. 2 represents an enlarged detail of the filter medium body 12 according to FIG. 1.

The filter medium body 12 is flowed through as intended from the raw-side inlet surface 50 to the clean-side outlet surface 52 by the fluid to be filtered, for example, air. The flow direction 134 is indicated by arrows. The filter medium body 12 illustrated in the embodiment comprises a flow-through medium 13 which is folded in a zigzag shape and is arranged transversely to the flow direction 134 of the fluid.

At least one region 80 between the inlet surface 50 and the outlet surface 52 is filled with the adsorption medium 82, for example with a particle-type or dust-type activated carbon 84, and arranged in intermediate spaces 21 of the flow-through medium 13. The region 80 is covered with a fluid-permeable cover medium 90, for example a spunbond nonwoven, at a peripheral rim 86 of the outlet surface 52.

The flow-through medium 13 is folded in a zigzag shape transversely to the flow direction 134. At the outflow side 72 of the filter medium body 12, the region 80 between a fold base 25 of folds 22 of the filter medium body 12 and a fold tip 24 of the folds 22 is filled with the adsorption medium 82. The cover medium 90 is arranged at the fold tips 24.

In FIG. 2, the fluid flow 134 in the interior of the filter medium body 12 is indicated. In this context, it may be observed that the fluid flows first at the inflow side 70 of the folds 22 of the filter medium body 12 before it passes through the flow-through medium 13 and is filtered thereby and continues to flow in the region 80 which is filled with the adsorption medium 82.

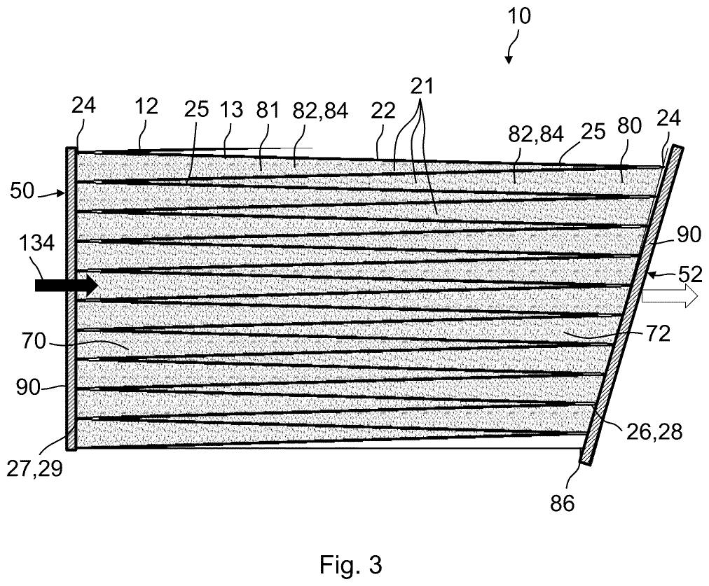

FIG. 3 shows an enlarged detail of the filter medium body 12 according to FIG. 1 in which the region 80 between the flow-through medium 13 and the outlet surface 52 as well as an inflow-side region 81 between the flow-through medium 13 and the inlet surface 50 is filled with the adsorption medium 82.

In this embodiment, intermediate spaces 21 of the flow-through medium 13 are filled from the inflow side 70 as well as from the outflow side 72 with the adsorption medium 82 so that the filter medium body 12 beneficially comprises a maximum load of the adsorption medium 82 for an adsorption performance as great as possible.

At the inflow side 70 and at the outflow side 72 of the folds 22 of the filter medium body 12, glue tracks 26, 27 may be expediently arranged along an unwind of the folds 22 of the flow-through medium 13 so that the cover medium 90 may be glued to the fold tips 24 of the folds 22 along the glue tracks 26, 27. In this way, both regions 80, 81 in which the adsorption medium 82 has been filled in are sealed relative to the environment and the adsorption medium 82 remains in the filter medium body 12.

Glue sections 28, 29 which extend across the fold tips 24 may be arranged at the inflow side 70 and at the outflow side 72, respectively. As an alternative or in addition, glue gaps 30, 31 which extend across the fold base 25 may be arranged at the outflow side 72 and/or at the inflow side 70, respectively. In this way, the cover medium 90 may be expediently glued to the glue sections 28, 29 at locations where glue sections 28, 29 are applied.

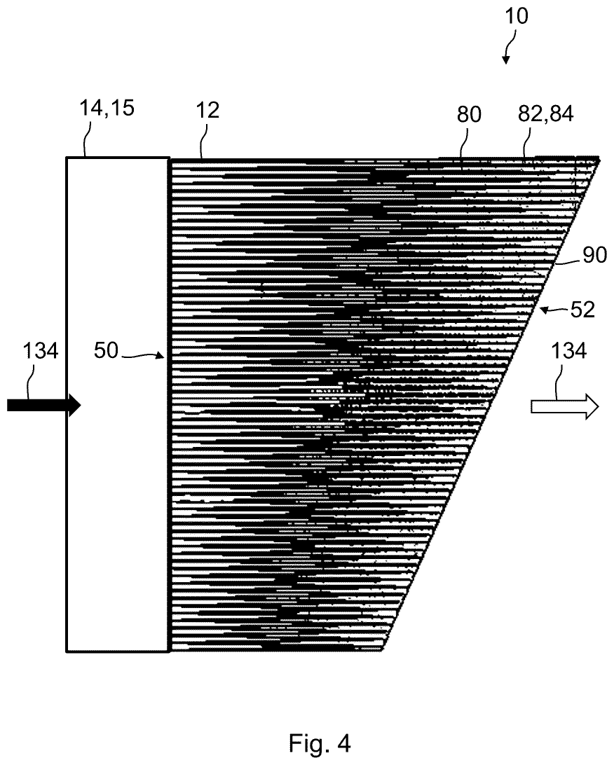

FIG. 4 shows a longitudinal section through a filter medium body 12 of a filter element 10 with a fluidly upstream arranged pre-separation stage 15 according to a further embodiment of the invention.

In front of the filter element 10, fluidly upstream thereof, a pre-separation stage 15, for example a cyclone pre-separator 14, may be arranged. A pre-separation stage 15 may thus be connected fluidly upstream to the filter medium body 12. In this context, paper bellows, nonwoven bellows, bellows of separator foams, single layer or multilayer, but also cyclone pre-separators may be employed as pre-separation stages 15. Accordingly, a filter medium body 12 which comprises a region 80, 81 with adsorption medium 82 may be combined with a pre-separation stage 15 in a filter element 10.

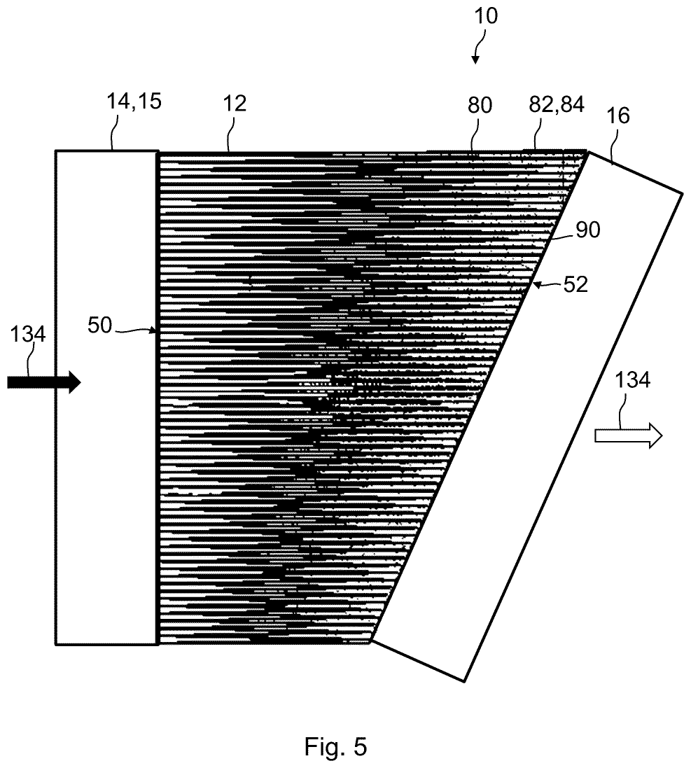

In FIG. 5, a longitudinal section through a filter medium body 12 of a filter element 10 with a fluidly upstream arranged pre-separation stage 15 and a fluidly downstream arranged safety element 16 is illustrated according to a further embodiment of the invention.

As an alternative or in addition, a safety element 16 may be arranged fluidly downstream behind the filter element 10. As a safety element 16, usually secondary filter elements may be used. Combinations of pre-separation stages 15 and safety elements 16 may be combined beneficially with the filter element 10 filled with the adsorption medium 82.

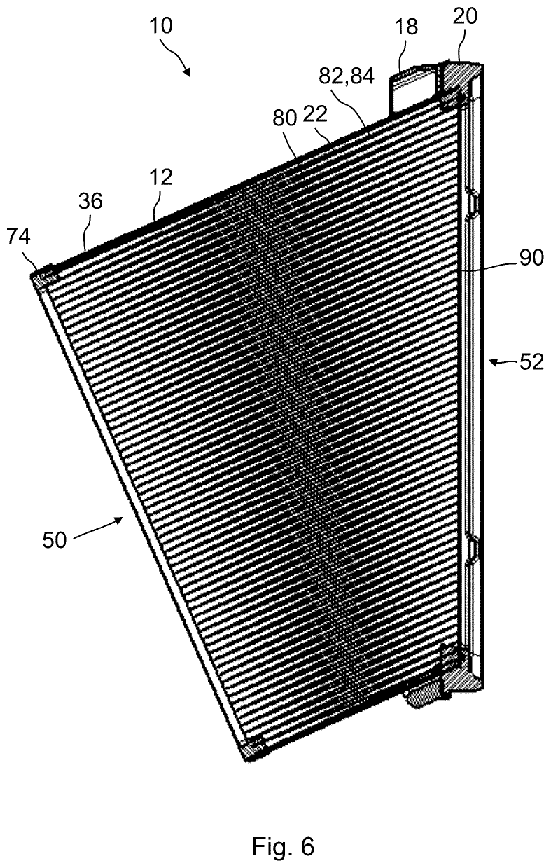

FIG. 6 shows a longitudinal section through a filter element 10 according to an embodiment of the invention.

In this embodiment, the filter medium body 12 is arranged in an element frame 36 and comprises at the outlet surface 52 a peripheral reinforcement frame 18, with a seal 20 which is arranged peripherally at least partially continuously at least in sections at an outer peripheral side of the flow-through medium 13 at the outlet surface 52 of the filter medium body 12. For example, the seal 20 may be connected to the reinforcement frame 18 by being foamed or molded on. In this context, the cover medium 90 may be connected expediently to the seal 20, for example tightly connected to the seal 20. The cover medium 90 may thus be connected to the reinforcement frame 18 by foaming or molding on the seal 20.

At a peripheral rim of the inlet surface 50, an edge protector 74 is attached in order to protect the filter medium body 12 from being damaged, for example, during mounting in a filter housing. The edge protector 74 may also be comprised of a molded-on plastic material.

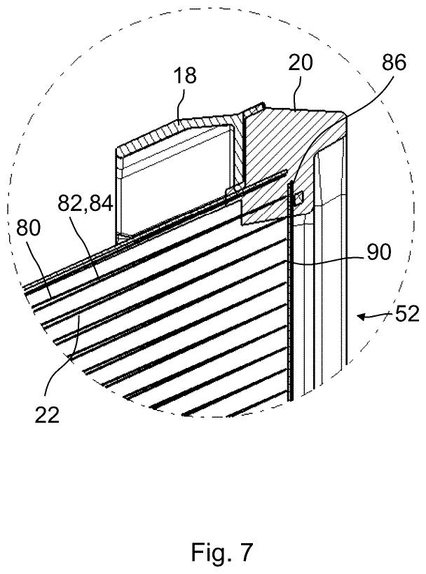

FIG. 7 shows in this context an enlarged detail of the filter element 10 according to FIG. 6 with focus on the reinforcement frame 18 and seal 20. In this context, it may be seen how the cover medium 90 is integrated at the peripheral rim 86 in the seal 20, for example, in the case of a polyurethane seal 20, embedded by foaming or molding on.

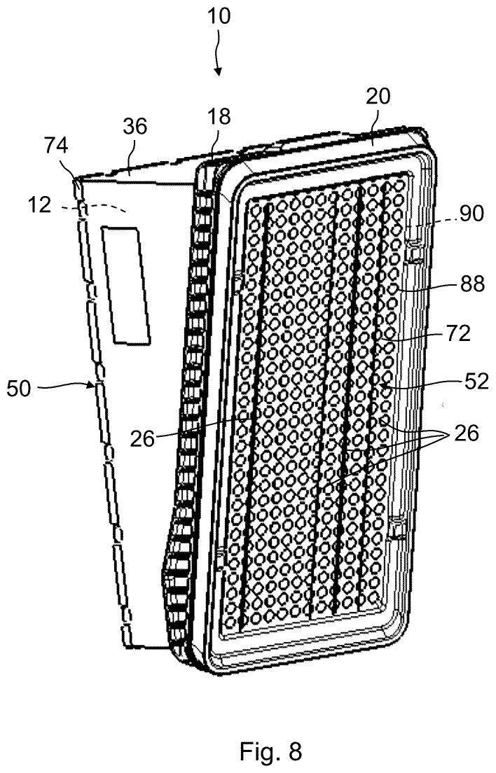

In FIG. 8, an isometric illustration of a filter element 10 according to a further embodiment of the invention with a view of the outlet surface 52 is illustrated.

The filter element 10 comprises a filter medium body 12 which is laterally enveloped by an element frame 36 at a peripheral rim 86 and comprises at the outlet surface 52 a peripheral reinforcement frame 18 which is closed by a peripheral seal 20.

The filter medium body 12 comprises in this context at the outflow side 72 a grid structure 88 in the form of a perforated plate for stabilization of the folds 22 against the pressure of the fluid flow. Expediently, in this embodiment the cover medium 90, which is arranged between filter medium body 12 and grid structure 88, may be connected to the grid structure 88. For example, the cover medium 90 may be glued by glue tracks 26, which are applied to the fold tips 24, not visible, to the fold tips 24 and pressed against the grid structure 88.

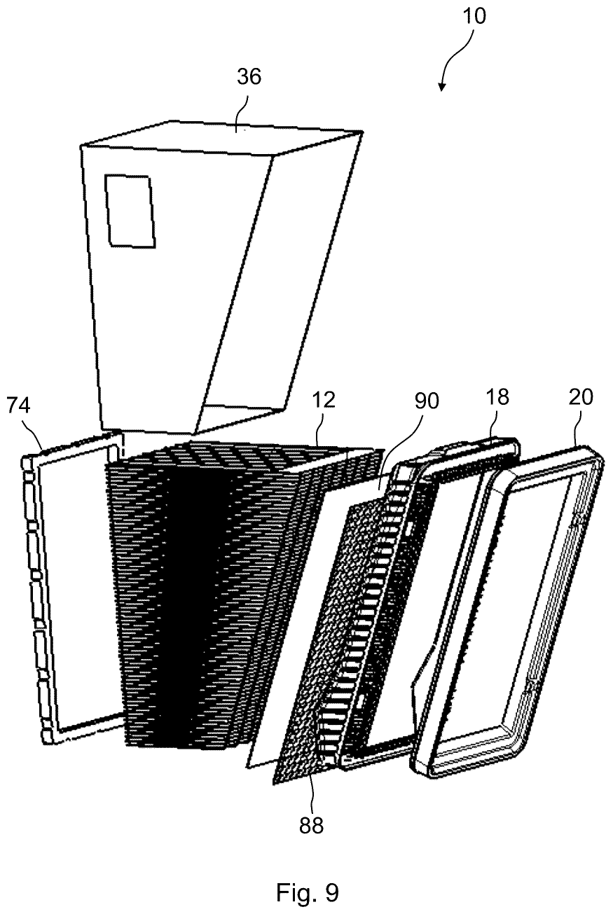

FIG. 9 shows an exploded illustration of a filter element 10 according to a further embodiment of the invention. In this context, the individual components of the filter element 10, filter medium body 12, element frame 36, edge protector 74, cover medium 90, grid structure 88, reinforcement frame 18, and seal 20 may be seen. The cover medium 90 is arranged between filter medium body 12, which is filled at least in regions with the adsorption medium 82, and the grid structure 88.

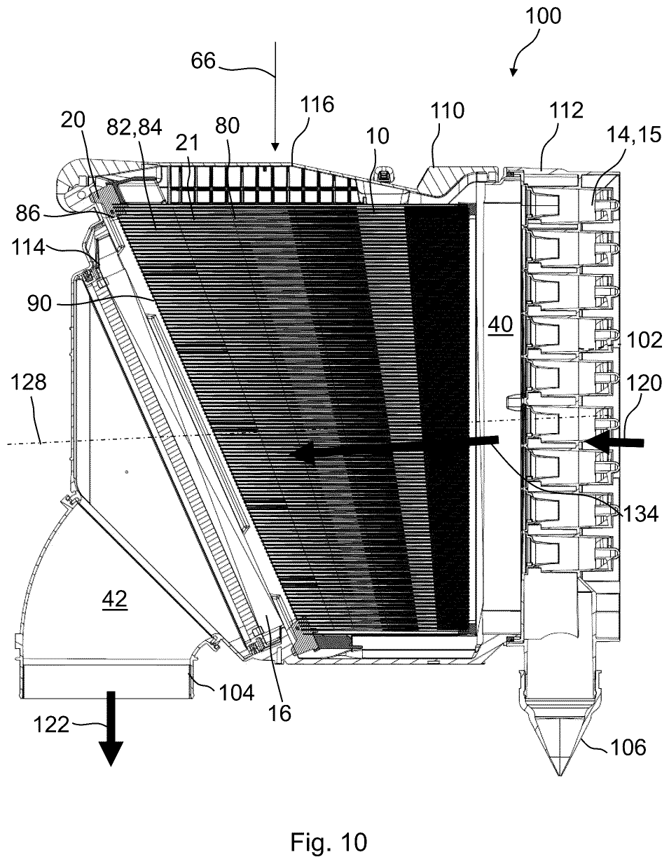

FIG. 10 shows a longitudinal section of a filter system 100 with a filter element 10 according to an embodiment of the invention.

The filter system 100 for filtering a fluid, for example air, comprises a filter housing 110 which comprises at least one inlet 102 for inflow of the fluid flow 120 and at least one outlet 104 for outflow of the purified fluid flow 122. The raw fluid flow 120 and the clean fluid flow 122 are marked, together with the flow direction 134 in the filter medium body 12, by arrows.

The filter housing 110 comprises two housing parts 112 and 114 which are connected to each other.

In the filter housing 110, between a raw-side 40 and a clean-side 42, an exchangeable filter element 10 for filtering the fluid is arranged, comprising at least one filter medium body 12 comprising a flow-through medium 13 arranged transversely to the flow direction 134 of the fluid, comprising a raw-side inlet surface 50 and a clean-side outlet surface 52.

In this context, at least one region 80 between the inlet surface 50 and the outlet surface 52 is filled with an adsorption medium 82, for example with a particle-type or dust-type activated carbon 84, and arranged in intermediate spaces 21 of the flow-through medium 13. The region 80 is covered with a fluid-permeable cover medium 90, for example a spunbond nonwoven, at a peripheral rim 86 of the outlet surface 52.

A pre-separation stage 15, for example a cyclone pre-separator 14, is arranged in the filter housing 110 further fluidly upstream in front of the filter element 10. Fluidly downstream behind the filter element 10, a safety element 16 is arranged. Furthermore, the filter housing 110 comprises a dirt outlet 106 for discharging dust and dirt separated by the pre-separation stage 15.

The filter element 10 may expediently be configured as an insertion filter element which is inserted or insertable into the filter housing 110 transversely to the main flow axis 128 of the fluid. The installation direction 66 for the insertion filter element is marked in the illustration. The filter element 10 may be exchanged via a removable housing cover 116.

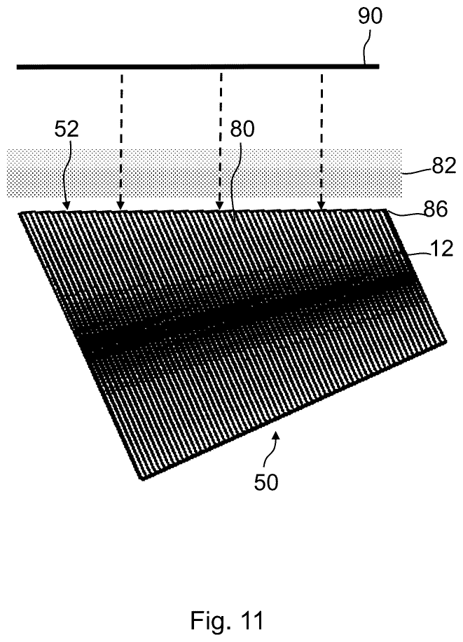

FIG. 11 shows a schematic illustration of a method for producing a filter element 10 according to an embodiment of the invention.

According to the proposed method, at least one region 80, 81 of intermediate spaces 21 of the flow-through medium 13 between the inlet surface 50 and the outlet surface 52 is filled with an adsorption medium 82, for example with particle-type or dust-type activated carbon 84. Subsequently, the region 80, 81 is covered with a fluid-permeable cover medium 90, for example a spunbond nonwoven, at a peripheral rim 86 of the inlet surface 50 and/or of the outlet surface 52.

In FIG. 11, filling in the adsorption medium 82 is illustrated in an exemplary fashion for the region 80 from the outlet surface 52 of the filter medium body 12. After filling in the adsorption medium 82, the region at the rim 86 is covered with the cover medium 90, for example, by gluing the cover medium 90 to the filter medium body 12.

In detail, the filter medium body 12 according to the proposed method is inserted into a receptacle with the inlet surface 50 or the outlet surface 52 accessible for filling and the receptacle is loaded into a filling station. Subsequently, the region 80, 81 of the filter medium body 12 is filled with the adsorption medium 82 via the accessible inlet surface 50 or outlet surface 52. Subsequently, the region 80, 81 at the inlet surface 50 or outlet surface 52 is covered with the cover medium 90.

For a two-sided filling of the filter medium body 12, the filter medium body 12 is rotated in the receptacle so that the region 80, 81 not yet filled is accessible for filling and the receptacle may be loaded into the filling station. Subsequently, the region 80, 81 of the filter medium body 12 which has not yet been filled is filled with the adsorption medium 82. Subsequently, this region 80, 81 at the inlet surface 50 or outlet surface 52 is also covered with the cover medium 90.

For covering the filter medium body 12 with the cover medium 90, at the inflow side 70 and/or at the outflow side 72 of folds 22 of the filter medium body 12 glue tracks 26, 27 may be arranged along an unwind of the folds 22 of the flow-through medium 13. In this manner, the cover medium 90 may be glued expediently to the fold tips 24 of the folds 22 along the glue tracks 26, 27.

Furthermore, the filter medium body 12 may be arranged in a reinforcement frame 18, with at least one seal 20 which is to be arranged peripherally at least partially continuously at least in sections at an outer peripheral side of the flow-through medium 13 at the inlet surface 50 or at the outlet surface 52 of the filter medium body 12. For example, the seal 20, which may be comprised, for example, of polyurethane, may be connected by foaming or molding to the reinforcement frame 18. The cover medium 90 in such an arrangement may be connected expediently to the seal 20 and for example may be embedded by foaming or molding into the seal 20.

In addition, a grid structure 88 for supporting the folds 22 of the filter medium body 12 against the pressure of the fluid flow may be arranged at the filter medium body 12 at the inflow side 70 and/or at the outflow side 72. In this context, the cover medium 90 may be connected expediently to the grid structure 88.

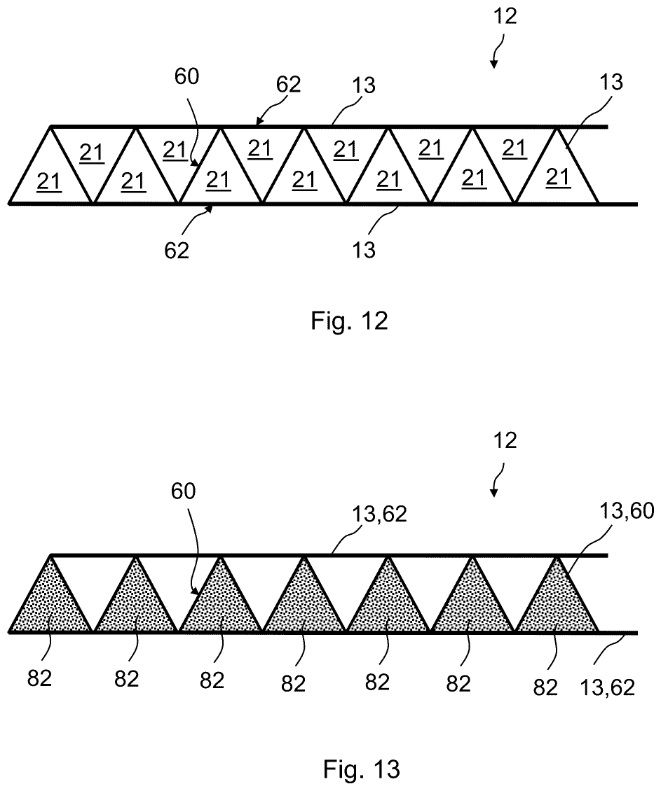

FIGS. 12 to 17 show further embodiments of the invention. In the configurations as filter medium body 12, the filter element 10 comprises a layer 60 of wavy or corrugated flow-through medium 13 and a layer 62 of flat flow-through medium 13. The flow-through medium 13 may be filter paper, for example.

The layers 60, 62 are placed on top of each other wherein the intermediate spaces 21 between the flow-through media 13 form channels. This is illustrated in FIG. 12 in schematic illustration in plan view of a leading edge of the channels. FIG. 13 shows the arrangement according to FIG. 12 in which partially channels are filled with adsorption medium 82 and other channels remain empty. Optionally, all channels may also be filled with adsorption medium 82, for example, activated carbon, or with ion exchanger or the like. The openings of the channels may be expediently closed alternatingly with a cover, for example, in the form of pasty glue beads which are applied onto the edge region.

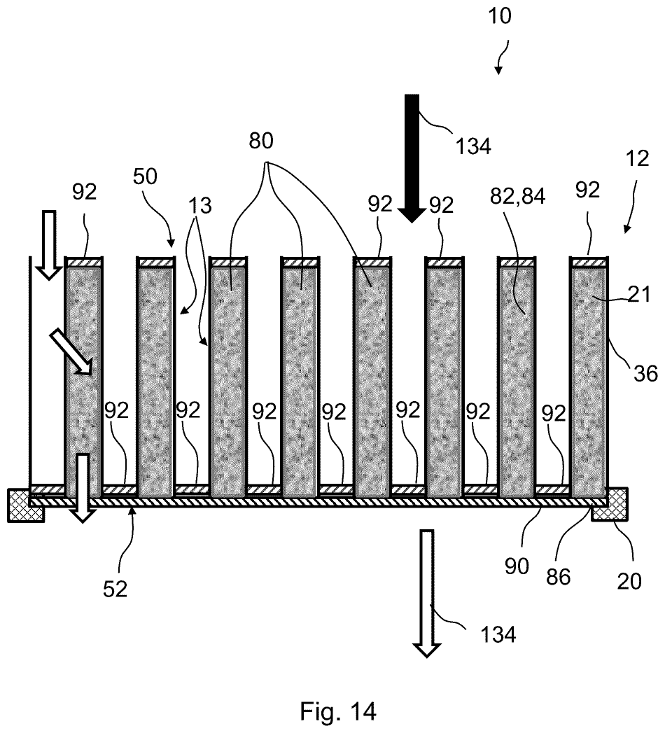

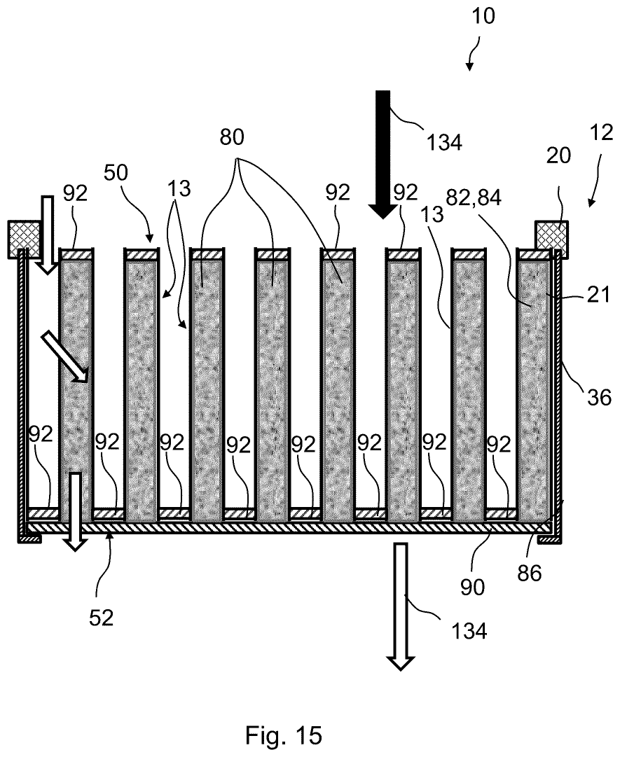

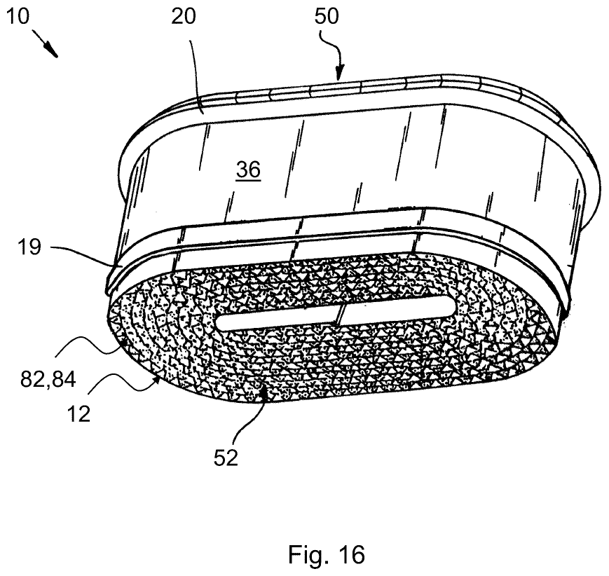

The layers 60, 62 of the medium 13 placed on top of each other may be wound (FIG. 16) or several such layers 60, 62 may be stacked on each other (FIGS. 14 and 15).

As may be seen in the arrangements of FIGS. 14 and 15 in side view, the openings of the channels are closed alternatingly by a cover 92, for example, in the form of pasty glue beads which are applied in the edge region of the channels alternatingly in a channel at the inlet side and in the neighboring channel at the outlet side.

The channels with a cover 92 at the inlet surface 50 for the fluid into the filter element 10 contain an adsorption medium 82, for example activated carbon 84, while the channels with a cover 92 at the outlet surface 52 for the fluid are free. From here, the fluid flows from the inlet surface 50 into the regions 80 with the adsorption medium 82, for example activated carbon 84, and exits from the outlet surface 52 at the bottom of the channel filled with the adsorption medium 82. At the outlet surface 52, a cover medium 90, for example, a spunbond nonwoven or the like, may be arranged which retains particles in the channel (region 80) filled with the adsorption medium 82.

FIG. 14 shows a longitudinal section through a filter element 10 in which a region 80 between the inlet surface 50 and the outlet surface 52 of the fluid to be filtered is filled with an adsorption medium 82, for example with a particle-type or dust-type activated carbon 84, and arranged in intermediate spaces 21 of the flow-through medium 13. The filter medium body 12 is arranged in an element frame 36 and comprises a peripheral seal 20 at the downstream side at the outlet surface 52. FIG. 15 shows a longitudinal section through a filter element 10 in which a region 80 between the inlet surface 50 and the outlet surface 52 is filled with an adsorption medium, for example with a particle-type or dust-type activated carbon 84, and arranged in intermediate spaces 21 of the flow-through medium 13. The filter medium body 12 is arranged in an element frame 36 and comprises a peripheral seal 20 at the upstream side at the inlet surface 50. At the outlet surface 52, the element frame 36 engages across a rim 86 of the filter medium body 12 so that the latter is held securely inside the element frame 36.

FIG. 16 shows an isometric view of a filter element 10 with a wound filter medium body according to FIG. 12 or FIG. 13. The filter medium body 12 is arranged inside an element frame 36. At the inlet surface 50 for the fluid a peripheral seal 20 is arranged. An optional emergency seal 19 is arranged near the outlet surface 52.

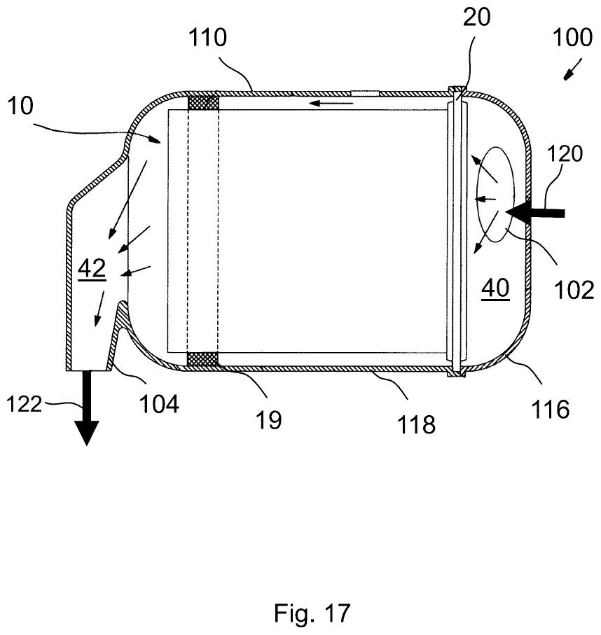

FIG. 17 shows a longitudinal section of a filter system 100 with the filter element 10 according to FIG. 16. A raw fluid flow 120 enters the filter housing 110 through an inlet 102. The filter element 10 is arranged between raw-side 40 and clean-side 42. The peripheral seal 20 seals the clean-side 42 in relation to the raw-side 40 and is clamped between housing cover 116 and housing pot 118. The clean fluid flow 122 exits through the outlet 104 from the housing 110.

Reference Characters

| | |
|---|---|
| 10 | filter element |
| 12 | filter medium body |
| 13 | flow-through medium |
| 14 | cyclone pre-separator |
| 15 | pre-separation stage |
| 16 | safety element |
| 18 | reinforcement frame |
| 19 | emergency seal |
| 20 | seal |
| 21 | intermediate space |
| 22 | fold |
| 24 | fold tip |
| 25 | fold base |
| 26 | glue track |
| 27 | glue track |
| 28 | glue section |
| 29 | glue section |
| 30 | glue gap |
| 31 | glue gap |
| 36 | element frame |
| 40 | raw-side |
| 42 | clean-side |
| 50 | inlet surface |
| 52 | outlet surface |
| 60 | corrugated layer |
| 62 | flat layer |
| 66 | installation direction |
| 70 | inflow side |
| 72 | outflow side |
| 74 | edge protector |
| 80 | region |
| 81 | region |
| 82 | adsorption medium |
| 84 | activated carbon |
| 86 | rim |
| 88 | grid structure |
| 90 | cover medium |
| 92 | cover |
| 100 | filter system |
| 102 | inlet |
| 104 | outlet |
| 106 | dirt outlet |
| 110 | filter housing |
| 112 | housing top part |
| 114 | housing bottom part |
| 116 | housing cover |
| 118 | housing pot |
| 120 | raw fluid flow |
| 122 | clean fluid flow |
| 128 | main flow axis |
| 134 | flow direction |

What is claimed is:

1. A filter element for filtering a fluid, the filter element comprising:
at least one filter medium body comprising a flow-through medium arranged transversely to a flow direction of the fluid and further comprising an inlet surface and an outlet surface;
wherein the flow-through medium comprises intermediate spaces;
wherein at least one region of the flow-through medium between the inlet surface and the outlet surface is filled with an adsorption medium arranged in the intermediate spaces;
a fluid-permeable cover medium covering the at least one region at a peripheral rim of the inlet surface and/or of the outlet surface.

2. The filter element according to claim 1, wherein the flow-through medium is folded in a zigzag shape transversely to the flow direction of the fluid and comprises folds each comprising a fold base and a fold tip, wherein the at least one region of the flow-through medium is filled with the adsorption medium between the fold bases and the fold tips of the folds at an inflow side and/or at an outflow side of the folds, and wherein the cover medium is arranged at the fold tips.

3. The filter element according to claim 2, further comprising glue tracks arranged along an unwind of the folds of the flow-through medium at the inflow side and/or at the outflow side of the folds, and wherein the cover medium is glued to the fold tips along the glue tracks.

4. The filter element according to claim 2, further comprising glue sections extending across the fold tips at the inflow side of the folds or at the outflow side of the folds, and wherein the cover medium is glued to the glue sections.

5. The filter element according to claim 1, wherein the at least one filter medium body comprises a flat medium, wherein the flow-through medium is a corrugated flow-through medium, and wherein the flat medium is applied to the corrugated flow-through medium.

6. The filter element according to claim 5, wherein the corrugated flow-through medium and the flat medium applied to the corrugated flow-through medium are wound to a coil.

7. The filter element according to claim 1, further comprising a reinforcement frame, wherein the at least one filter medium body is arranged in the reinforcement frame, and wherein at least one seal is arranged peripherally at least partially continuously at least in sections at an outer peripheral side of the flow-through medium at the inlet surface or at the outlet surface of the at least one filter medium body.

8. The filter element according to claim 7, wherein the cover medium is connected to the at least one seal.

9. The filter element according to claim 1, wherein the at least one filter medium body comprises a grid structure at the inflow side and/or at the outflow side, and wherein the cover medium is connected to the grid structure.

10. A filter system for filtering a fluid, the filter system comprising:
a filter housing comprising at least one inlet for inflow of the fluid and at least one outlet for outflow of the fluid;
a filter element configured to filter the fluid, wherein the filter element is exchangeably arranged in the filter housing between a raw-side and a clean-side of the filter housing;
the filter element comprising at least one filter medium body comprising a flow-through medium arranged transversely to a flow direction of the fluid and further comprising an inlet surface and an outlet surface;
wherein the flow-through medium comprises intermediate spaces;
wherein at least one region of the flow-through medium between the inlet surface and the outlet surface is filled with an adsorption medium arranged in the intermediate spaces;
the filter element further comprising a fluid-permeable cover medium covering the at least one region at a peripheral rim of the inlet surface and/or of the outlet surface.

11. The filter system according to claim 10, further comprising a pre-separation stage arranged in the filter housing fluidly upstream in front of the filter element.

12. The filter system according to claim 10, further comprising a safety element arranged fluidly downstream behind the filter element.

13. The filter system according to claim 10, wherein the filter element is an insertion filter element configured to be inserted into the filter housing transversely to a main flow axis of the fluid.

14. A method for producing a filter element for filtering a fluid, the filter element comprising at least one filter medium body comprising a flow-through medium arranged transversely to a flow direction of the fluid and further comprising an inlet surface and an outlet surface; the method comprising:
filling an adsorption medium into at least one region of intermediate spaces of the flow-through medium between the inlet surface and the outlet surface; and
covering the at least one region with a fluid-permeable cover medium at a peripheral rim of the inlet surface and/or the outlet surface.

15. The method according to claim 14, further comprising:
inserting the at least one filter medium body into a receptacle such that one of the inlet surface and the outlet surface is accessible for filling and subsequently loading the receptacle into a filling station;
filling the adsorption medium into the at least one region through the one of the inlet surface and the outlet surface which is accessible for filling; and
covering the at least one region with the fluid-permeable cover medium at the one of the inlet surface and the outlet surface which is accessible for filling.

16. The method according to claim 15, further comprising:
rotating the at least one filter medium body in the receptacle so that the other one of the inlet surface and the outlet surface is accessible for filling and subsequently loading the receptacle into the filling station;
filling the adsorption medium into the at least one region through the other one of the inlet surface and the outlet surface which is accessible for filling; and
covering the at least one region with the fluid-permeable cover medium at the other one of the inlet surface and the outlet surface which is accessible for filling.

17. The method according to claim 14, further comprising:
arranging glue tracks along an unwind of folds of the flow-through medium at an inflow side and/or at an outflow side of the folds of the flow-through medium; and
gluing the fluid-permeable cover medium to fold tips of the folds of the flow-through medium along the glue tracks.

18. The method according to claim 14, further comprising:
arranging the at least one filter medium body in a reinforcement frame;
arranging at least one seal peripherally at least partially continuously at least in sections at an outer peripheral side of the flow-through medium at the inlet surface or at the outlet surface of the at least one filter medium body; and
connecting the fluid-permeable cover medium to the at least one seal.

19. The method according to claim 18, further comprising connecting the fluid-permeable cover medium to the at least one seal by foaming or molding the at least one seal to the fluid-permeable cover medium and/or connecting the at least one seal by foaming or molding to the reinforcement frame.

20. The method according to claim 14, further comprising arranging a grid structure on the at least one filter medium body at the inflow side and/or at the outflow side and connecting the fluid-permeable cover medium to the grid structure.
